(19) United States
(12) Patent Application Publication
(10) Pub. No.: US 2019/0347299 A1
(43) Pub. Date: Nov. 14, 2019

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJI XEROX CO., LTD., Tokyo (JP)

(72) Inventor: Saneyuki KOBAYASHI, Kanagawa (JP)

(73) Assignee: FUJI XEROX CO., LTD., Tokyo (JP)

(21) Appl. No.: 16/351,539

(22) Filed: Mar. 13, 2019

(30) Foreign Application Priority Data
May 11, 2018 (JP) 2018-092000

(51) Int. Cl. G06F 16/93; G06F 17/22; G06F 16/28; G06F 9/54

(52) U.S. Cl. CPC G06F 16/93; G06F 9/542; G06F 16/282; G06F 17/2288

(57) ABSTRACT

An information processing apparatus includes a detection unit that detects a changed part of a document including plural elements having a hierarchical structure, a specification unit that specifies an approver associated with an element to which the part belongs in the document, and a notification unit that notifies the approver of an approval request for the part.

### CROSS-REFERENCE TO RELATED APPLICATIONS

This application is based on and claims priority under 35 USC 119 from Japanese Patent Application No. 2018-092000 filed May 11, 2018.

### BACKGROUND

### (i) Technical Field

The present invention relates to an information processing apparatus, an information processing system, and a non-transitory computer readable medium storing a program.

### (ii) Related Art

JP2012-134603A discloses an information processing apparatus that divides document data on a per-page basis and receives setting of an approval request destination so as to receive approval for each divided document data. The information processing apparatus transfers the divided document data to the received approval request destination, receives approval information for the transferred document data from a client terminal, and transmits all the document data to a transmission destination in a case of determining that the approval information for all the document data is received.

### SUMMARY

In recent years, documents (structured documents) structured by markup languages or the like are often used. In the structured document, since elements constituting the document are clear, the document can be approved on a per-element basis, in addition to a per-document basis, a per-page basis, or the like. In this case, since approvers may only approve the element for which the approvers are responsible, respective approvers can approve plural elements included in one document in parallel.

However, especially in a hierarchical structured document, there are cases where approvers differ in the higher hierarchy and the lower hierarchy, which makes it difficult to specify the approver.

Aspects of non-limiting embodiments of the present disclosure relate to an information processing apparatus, an information processing system, and a non-transitory computer readable medium storing a program, for specifying an approver who requests approval of the document when the document is changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a detection unit that detects a changed part of a document including a plurality of elements having a hierarchical structure; a specification unit that specifies an approver associated with an element to which the part belongs in the document; and a notification unit that notifies the approver of an approval request for the part.

### BRIEF DESCRIPTION OF THE DRAWINGS

Exemplary embodiment(s) of the present invention will be described in detail based on the following figures, wherein:

FIG. 1 is a diagram illustrating a configuration of an information processing system 9 according to the present exemplary embodiment;

FIG. 2 is a diagram illustrating a configuration of an information processing apparatus 1;

FIG. 3 is a diagram illustrating an example of a document DB 123 stored in a storage unit 12;

FIG. 4 is a diagram illustrating an example of an element DB 121 stored in the storage unit 12;

FIG. 5 is a diagram illustrating an example of a structure of a document;

FIG. 6 is a diagram for explaining a relationship between a position of a description in a document and elements constituting the document;

FIG. 7 is a diagram illustrating an example of an approval DB 122 stored in the storage unit 12;

FIG. 8 is a diagram illustrating an example of a configuration of a terminal 2;

FIG. 9 is a diagram illustrating a functional configuration of the information processing system 9;

FIG. 10 is a flowchart illustrating a flow of an operation until the information processing apparatus 1 specifies an approver; and

FIG. 11 is a flowchart illustrating a flow of an operation in which the information processing apparatus 1 notifies the approver of an approval request.

### DETAILED DESCRIPTION

### Exemplary Embodiment

Entire Configuration of Information Processing System

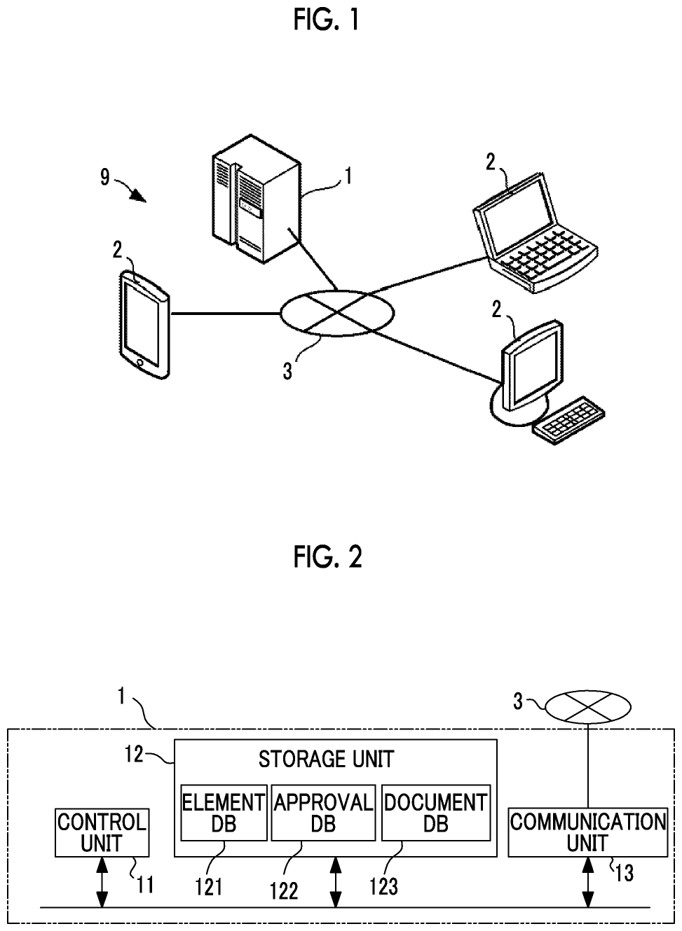

FIG. 1 is a diagram illustrating a configuration of an information processing system 9 according to an exemplary embodiment. The information processing system 9 includes an information processing apparatus 1 and plural terminals 2, and also includes a communication line 3 for communicably connecting the information processing apparatus 1 and the plural terminals 2. The information processing system 9 may have plural information processing apparatuses 1.

The information processing apparatus 1 is an information processing apparatus that stores an approver in association with each element of a document. “Document” is information configured with plural elements recorded as electronic data indicating texts, symbols, drawings, and the like, respectively. Examples of documents include business standards defining how to proceed, guidelines, points of attention, and the like, operation manuals for machinery and equipment, manuals for writing and drawing, manuals on customer service, handbook for examination, and the like.

“Hierarchical structure” is a structure with layered overlap. A document handled by the information processing apparatus 1 is a document configured with plural elements having a hierarchical structure, among the above-described documents, and examples include a structured document written in markup language, a fixed form document in which predetermined words (reserved words) are arranged according to the rules, or the like.

The terminal 2 is a terminal such as a computer operated by each user of the information processing system 9. As the user of the information processing system 9, there are a creator who creates a document, an approver who approves an element defined for each element included in the created document, a requester who requests approval from the approver, or the like.

The communication line 3 may be, for example, a local area network (LAN), a wide area network (WAN), the Internet, or a combination thereof. Further, the communication line 3 may include public switched telephone networks (PSTN), integrated services digital network (ISDN), or the like.

Configuration of Information Processing Apparatus

FIG. 2 is a diagram illustrating the configuration of the information processing apparatus 1. As illustrated in FIG. 2, the information processing apparatus 1 includes a control unit 11, a storage unit 12, and a communication unit 13.

The control unit 11 includes a central processing unit (CPU), a read only memory (ROM), and a random access memory (RAM), and the CPU reads out and executes the computer program (hereinafter referred to simply as “program”) stored in the ROM and the storage unit 12 to control each unit of the information processing apparatus 1.

The communication unit 13 is a communication circuit which is connected to the communication line 3 by wire or wireless. The information processing apparatus 1 exchanges information with the terminal 2 connected to the communication line 3 by the communication unit 13.

The storage unit 12 is storage means such as a hard disk drive, and stores various programs, data, and the like which are read into the CPU of the control unit 11. Further, the storage unit 12 stores an element DB 121, an approval DB 122, and a document DB 123.

Configuration of Document DB

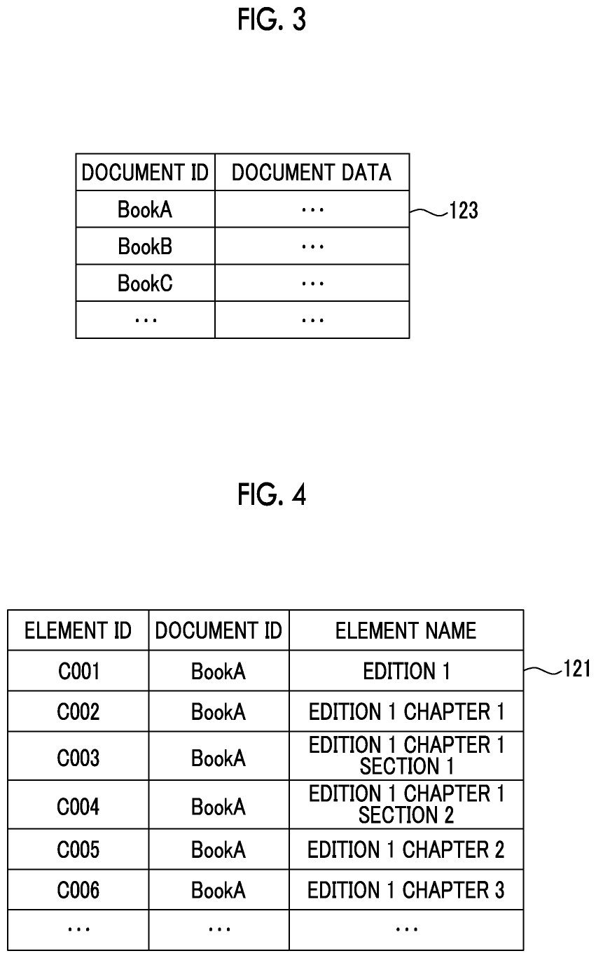

FIG. 3 is a diagram illustrating an example of the document DB 123 stored in the storage unit 12. The document DB 123 illustrated in FIG. 3 is a database that stores a document ID, which is identification information for identifying a document, and document data indicating the content of the document in association with each other.

Configuration Element DB

FIG. 4 is a diagram illustrating an example of the element DB 121 stored in the storage unit 12. The element DB 121 illustrated in FIG. 4 is a database that associates a document with elements constituting the document.

In the element DB 121, in association with the element ID which is the identification information of each of elements constituting the document, the document ID of the document including the element and the element name which is the name of the element are described. For example, the element ID of “edition 1” of the document identified by the document ID “BookA” is “C001”.

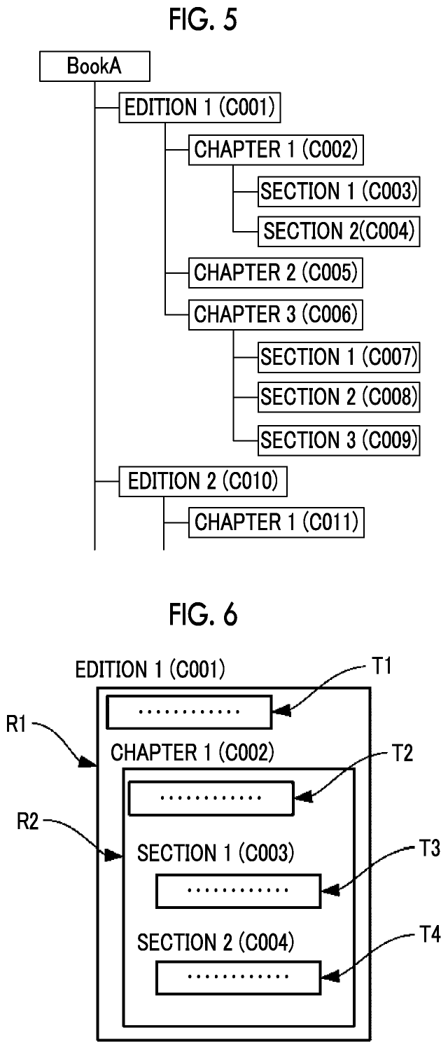

FIG. 5 is a diagram illustrating an example of the structure of a document. For example, “edition 1” of “BookA” illustrated in FIG. 5 includes “chapter 1”, “chapter 2”, “chapter 3”, and . . . . Therefore, “chapter 1”, “chapter 2”, “chapter 3”, and . . . have an inclusive relationship with “edition 1” and are lower elements of “edition 1”. The “chapter 1” includes “section 1” and “section 2”. Therefore, the “section 1” and “section 2” have an inclusive relationship with “chapter 1” and are lower elements to “chapter 1”, and have an inclusive relationship with “edition 1” and are lower elements of “edition 1”.

FIG. 6 is a diagram for explaining a relationship between a position of a description in a document and elements constituting the document. The positions T1, T2, T3, and T4 are examples of the positions of descriptions in the document. The position T1 is included in the range R1 constituting the edition 1 (C001), but is not included in the chapter 1 (C002) which is the lower element of the edition 1. The position T1 is, for example, a position at which the headline sentence or abstract of the edition 1 is described. The element including the position T1 is the edition 1 (C001), and there is no element including the position T1 in the higher hierarchy or lower hierarchy.

On the other hand, the position T2 is included in the range R2 constituting the chapter 1 (C002), but is not included in any of the section 1 (C003) and the section 2 (C004) which are the lower elements of the chapter 1. The position T2 is, for example, a position at which the headline sentence or abstract of the chapter 1 is described. There are two elements including position T2, that is, chapter 1 and edition 1, and chapter 1 is a lower element of edition 1.

The position T3 is included in the section 1 (C003). The position T3 is, for example, the position where the text of the section 1 is described. That is, there are three elements including the position T3, namely, the section 1, the chapter 1, and the edition 1, which are arranged in the order from the lower element to the higher element, the section 1→the chapter 1→the edition 1.

Further, the position T4 is included in the section 2 (C004). The position T4 is, for example, the position where the text of the section 2 is described. That is, there are three elements including the position T4, namely, the section 2, the chapter 1, and the edition 1, which are arranged in the order from the lower element to the higher element, the section 2→the chapter 1→the edition 1.

Configuration Approval DB

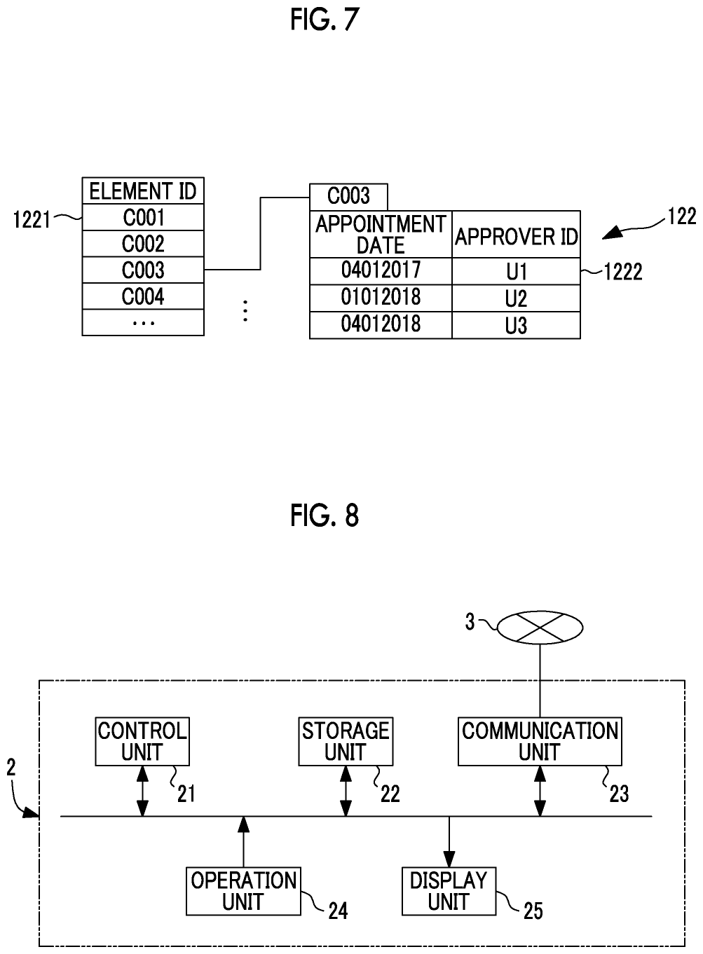

FIG. 7 is a diagram illustrating an example of the approval DB 122 stored in the storage unit 12. The approval DB 122 illustrated in FIG. 7 is a database that stores approvers who approve the elements for each element constituting the document. The approval DB 122 illustrated in FIG. 7 includes an element ID list 1221 listing element IDs and an approver table 1222. The approver table 1222 is assigned one by one for each element ID stored in the element ID list 1221.

The approver table 1222 stores the identification information (approver ID) of the approver who has appointed the role of approving the element identified by the assigned element ID and a day (appointment date) when each approver has appointed in association with each other.

By referring to the approval DB 122, the information processing apparatus 1 specifies the appointment date of each of the approvers who have appointed the role of approving the element, for each of the plural elements constituting the document, and specifies approvers who are assigned at some time point in the past or current, for the element.

Configuration of Terminal

FIG. 8 is a diagram illustrating an example of a configuration of the terminal 2. The terminal 2 illustrated in FIG. 8 includes a control unit 21, a storage unit 22, a communication unit 23, an operation unit 24, and a display unit 25.

The control unit 21 includes a CPU, a ROM, and a RAM, and the CPU reads out and executes the program stored in the ROM or the storage unit 22 to control each unit of the terminal 2. The storage unit 22 is storage means such as a solid state drive or a hard disk drive, and stores various programs, data, and the like which are read into the CPU of the control unit 21.

The communication unit 23 is a communication circuit which is connected to the communication line 3 by wire or wireless. The terminal 2 exchanges information with the information processing apparatus 1 connected to the communication line 3 by the communication unit 23.

The operation unit 24 is equipped with operators such as operation buttons for giving various instructions, a keyboard, and a touch panel, receives an operation by a user, and sends a signal corresponding to the operation content to the control unit 21.

The display unit 25 includes a display screen such as a liquid crystal display, and displays an image under the control of the control unit 21. A transparent touch panel of the operation unit 24 may be disposed so as to be superimposed on the display screen.

Functional Configuration of Information Processing System

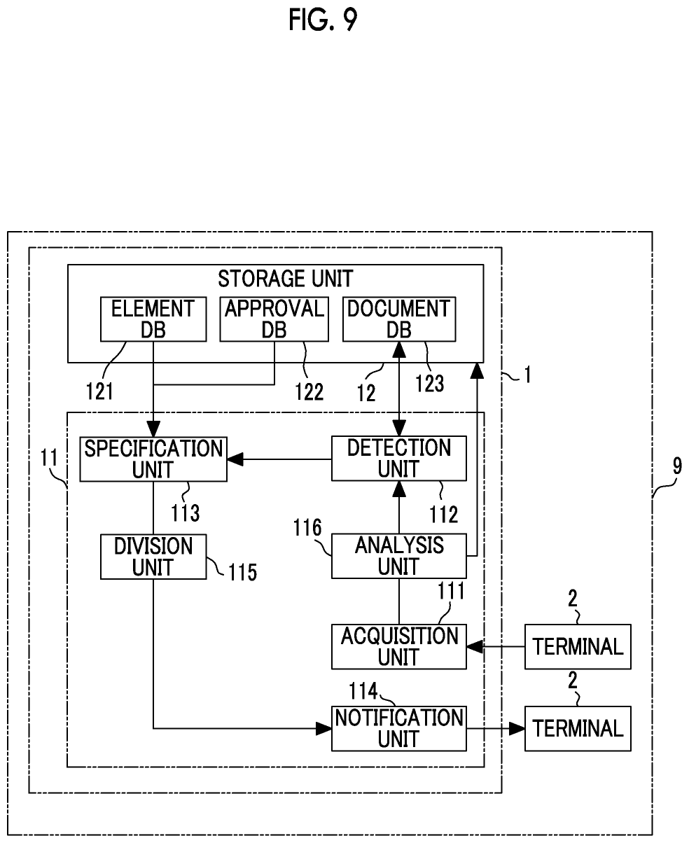

FIG. 9 is a diagram illustrating a functional configuration of the information processing system 9. In FIG. 9, a description of each configuration of the communication unit 13, the communication line 3, and the terminal 2 of the information processing apparatus 1 is omitted.

The control unit 11 of the information processing apparatus 1 functions as an acquisition unit 111, a detection unit 112, a specification unit 113, and a notification unit 114 by reading and executing the program stored in the storage unit 12. Further, the control unit 11 may further function as a division unit 115 and an analysis unit 116.

The acquisition unit 111 acquires an instruction corresponding to the operation from the terminal 2 that receives the operation of the user.

For example, in the terminal 2, in a case where a user (creator) who creates the document performs an operation to instruct registration of the document, the acquisition unit 111 acquires a document and an instruction to register the document from the terminal 2.

In this case, the analysis unit 116 analyzes the document acquired by the acquisition unit 111 and extracts the elements constituting the document. For example, in a case where the document is a structured document written in a markup language, this analysis is performed based on the tag defined by the markup language. In addition, this analysis is performed by natural language analysis in a case where the document is described in natural language. In the natural language analysis, for example, elements are extracted by detecting reserved words such as “edition”, “chapter”, “section”, “term”, “eye” and the like in sentences. The analysis unit 116 assigns an element ID to each extracted element and registers the element ID in the element DB 121.

In a case where it is detected that the document violates the predetermined form as a result of the analysis, the information processing apparatus 1 may notify the creator of the document to the fact. For example, in a case where a tag is not described in accordance with the grammar of the markup language, a case where the order, position, or the like of the reserved word is wrong, a case where element names in the document are not uniquely specified, or the like, the information processing apparatus 1 may detect these errors and notify the creator of the document of the errors.

Further, for example, in the terminal 2, in a case where a user who determines an approver of an element constituting a document performs an operation to instruct registration of the approver of the element, the acquisition unit 111 acquires an element ID indicating the element and an approver ID indicating the approver of the element, from the terminal 2.

In this case, the analysis unit 116 receives the element ID and the approver ID acquired by the acquisition unit 111, and registers the received element ID and approver ID in the approval DB 122 of the storage unit 12 in association with each other.

Further, for example, in the terminal 2, in a case where a user who has made a change to a document performs an operation to request approval for the document, the acquisition unit 111 acquires the document to which the change has been made, from the terminal 2.

The detection unit 112 compares the document acquired by the acquisition unit 111 with the document before the change of the document, and detects the changed part of the document.

The specification unit 113 refers to the element DB 121 and the approval DB 122 and specifies the current approver associated with the element to which the detected part, that is, the changed part of the document belongs. The current approver is specified based on the new appointment date associated in the approver table 1222 of the approval DB 122.

The notification unit 114 notifies the approver specified by the specification unit 113 of the approval request of the changed part described above.

In a case where the detection unit 112 detects plural parts and the specification unit 113 specifies a common approver for each of the plural parts, the notification unit 114 may collectively notify of the approval requests of the plural parts.

Further, the control unit 11 may function as the division unit 115 as described above. The division unit 115 divides the element to which the changed part of the document belongs, from the document. In this case, the notification unit 114 may notify of the approval request of the changed part and may notify of the divided elements. According to this configuration, the approver does not have to look at elements other than the element for which the approval is requested.

In a case where there are plural elements to which the changed part of the document belongs, the specification unit 113 may specify the approvers associated with each of the plural elements. In this case, in a case where plural approvers are specified, the notification unit 114 may notify of the request in order from the approver associated with the lower element to the approver associated with the higher element.

Operation of Information Processing System

Operation for Specifying Approver

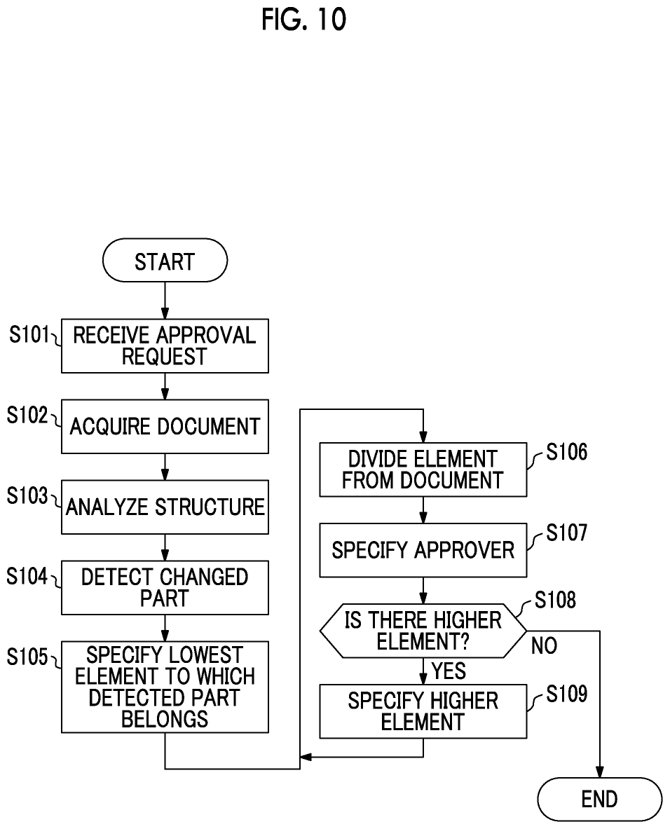

FIG. 10 is a flowchart illustrating a flow of an operation until the information processing apparatus 1 of the information processing system 9 specifies an approver.

As illustrated in FIG. 10, in a case of receiving an approval request of a document including a part changed by the user from the terminal 2 (step S101), the control unit 11 of the information processing apparatus 1 acquires the document (step S102), and analyzes the structure of the document (step S103).

In a case of acquiring a document equivalent to before the change of the acquired document, for example, from the storage unit 12, the control unit 11 compares the two documents before and after the change and detects a part changed by the user (step S104). Then, the lowest element to which the detected part belongs is specified (step S105).

The control unit 11 may divide the element specified in step S105 from the document (step S106).

The control unit 11 refers to the approval DB 122 and specifies an approver associated with the element specified in step S105 (step S107).

In a case where there are plural elements to which the changed part of the document belongs, the control unit 11 may specify the approvers associated with each of the plural elements, in step S107. In this case, the control unit 11 may determine whether or not there is an element to which the above-described part belongs, in the higher hierarchy of the specified element (step S108).

In a case where it is determined that there is no element in the higher hierarchy (step S108; NO), the control unit 11 terminates the process. On the other hand, in a case where it is determined that there is an element in the higher hierarchy (step S108; YES), the control unit 11 specifies a higher element (step S109) and returns the process to step S106. In a case where there are plural higher elements in step S109, the control unit 11 specifies an element with hierarchy one level higher of the element of which approver is specified in step S107, that is, a chapter with hierarchy one level higher in a case where the element of which approver is specified in step S107 is a section, or an edition in a case of a chapter.

In a case where there are plural elements to which the changed part of the document belongs, the control unit 11 may specify one approver associated with one element among the plural elements. In this case, for example, the control unit 11 specifies one approver associated with the lowest element among the plural elements.

Operation of Notification of Approval Request

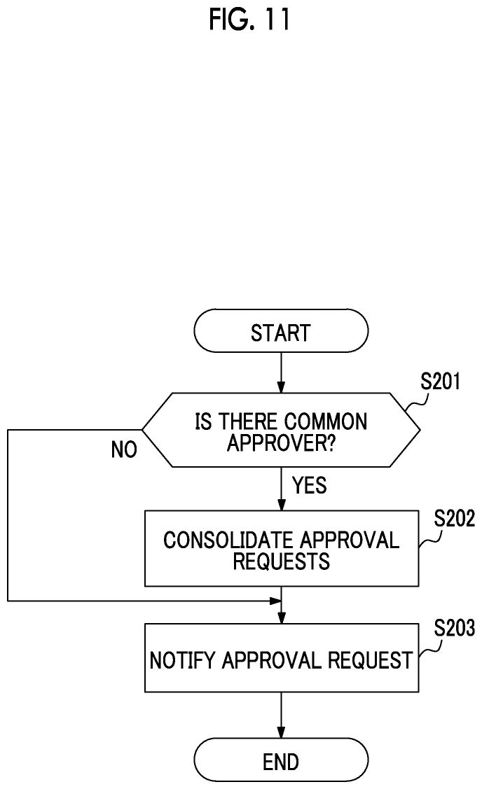

FIG. 11 is a flowchart illustrating a flow of an operation in which the information processing apparatus 1 of the information processing system 9 notifies the approver of an approval request.

As illustrated in FIG. 11, in a case where plural approvers are specified in the above-described step S107, the control unit 11 of the information processing apparatus 1 determines whether or not there is a common approver among the plural approvers (step S201).

In a case where it is determined that there is a common approver (step S201; YES), the control unit 11 consolidates the approval requests to be notified to the common approver into one (step S202), and proceeds to the process of step S203.

On the other hand, in a case where it is determined that there is no common approver (step S201; NO), the control unit 11 proceeds to the process of step S203 without proceeding to step S202.

The control unit 11 notifies each of the specified approvers of the approval request (step S203). In this case, one approval request into which the approval requests are consolidated in step S202 is notified at once to the corresponding approvers.

In a case where the element specified in step S105 is divided from the document, in step S203, the control unit 11 notifies of the divided element and the approval request for the changed part included in the element.

Further, in a case where the approver associated with each of the plural elements to which the changed part of the document belongs is specified in order from the lowest element to the higher element, the control unit 11 may notify the above-described approval request in this order.

Thus, the approval requests for the changed part are notified to the associated approvers in the order in which the hierarchy of the element to which the part belongs moves from the lower hierarchy to the higher hierarchy.

With the above operation, in the information processing system 9, when a document is changed, an approver who requests approval of the document is specified.

### MODIFICATION EXAMPLES

The above is the explanation of an exemplary embodiment, but the contents of the exemplary embodiment can be modified as follows. Further, the following modification examples may be combined.

### Modification Example 1

The detection unit 112 may detect the timing at which the above-described part is changed, with reference to the metadata or the like included in the acquired document data. In this case, the specification unit 113 specifies the approver associated with a pair of the element to which the detected part belongs and the detected timing. The notification unit 114 may notify the approver associated with the pair of the element to which the changed part belongs and the timing at which the part is changed of the approval request of the part.

For example, in a case where the part belonging to edition 1, chapter 1, section 1 of BookA is changed on Apr. 2, 2017 by the user, the element ID indicating the element is “C003”, and in the approval DB 122 illustrated in FIG. 7, the approver ID indicating the current approver is “U3”. However, the approver ID of the approver associated with the timing at which the part is changed is “U1”. Therefore, the information processing apparatus 1 may notify the person with the approver ID “U3” of the approval request and may also notify the person with the approver ID “U1” of the approval request. In this case, the person with the approver ID “U1” which is the past approver may assist the person with the approver ID “U3” which is the current approver.

### Modification Example 2

In a case where a predetermined period has not elapsed since an approver (a first approver) associated with the above-described element at the current time is appointed, the specification unit 113 may specify an approver (a second approver) associated with a pair of the element and the timing at which the part belonging to the element is changed. In this case, the notification unit 114 may notify the above-described second approver, in addition to or in place of the above-described first approver, of the approval request.

### Modification Example 3

The program executed by the control unit 11 of the information processing apparatus 1 can be provided by being stored in a computer readable recording medium such as a magnetic recording medium such as a magnetic tape and a magnetic disk, an optical recording medium such as an optical disk, a magneto-optical recording medium, and a semiconductor memory. Further, this program may be downloaded through a communication line such as the Internet. As control means exemplified by the above-described control unit 11, various devices other than the CPU may be applied, for example, a dedicated processor or the like is used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detection unit that detects a changed part of a document including a plurality of elements having a hierarchical structure;
a specification unit that specifies an approver associated with an element to which the part belongs in the document; and
a notification unit that notifies the approver of an approval request for the part.

2. The information processing apparatus according to claim 1,
wherein the detection unit detects a timing at which the part is changed,
wherein the specification unit specifies the approver associated with a pair of the element and the timing.

3. The information processing apparatus according to claim 2,
wherein in a case where a predetermined period has not elapsed since a first approver associated with the element at a current time is appointed, the specification unit specifies a second approver associated with the pair of the element and the timing, and
wherein in a case where the second approver is specified, the notification unit notifies the second approver of the request.

4. The information processing apparatus according to claim 1,
wherein in a case where the detection unit detects a plurality of the parts and the specification unit specifies a common approver for each of the plurality of parts, the notification unit collectively notifies of approval requests of the plurality of parts.

5. The information processing apparatus according to claim 2,
wherein in a case where the detection unit detects a plurality of the parts and the specification unit specifies a common approver for each of the plurality of parts, the notification unit collectively notifies of approval requests of the plurality of parts.

6. The information processing apparatus according to claim 1, further comprising:
a division unit that divides the element to which the part belongs in the document, from the document
wherein the notification unit notifies of the divided element and the request.

7. The information processing apparatus according to claim 2, further comprising:
a division unit that divides the element to which the part belongs in the document, from the document
wherein the notification unit notifies of the divided element and the request.

8. The information processing apparatus according to claim 3, further comprising:
a division unit that divides the element to which the part belongs in the document, from the document
wherein the notification unit notifies of the divided element and the request.

9. The information processing apparatus according to claim 4, further comprising:
a division unit that divides the element to which the part belongs in the document, from the document
wherein the notification unit notifies of the divided element and the request.

10. The information processing apparatus according to claim 5, further comprising:
a division unit that divides the element to which the part belongs in the document, from the document
wherein the notification unit notifies of the divided element and the request.

11. The information processing apparatus according to claim 1,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

12. The information processing apparatus according to claim 2,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

13. The information processing apparatus according to claim 3,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

14. The information processing apparatus according to claim 4,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

15. The information processing apparatus according to claim 5,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

16. The information processing apparatus according to claim 6,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

17. The information processing apparatus according to claim 7,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

18. The information processing apparatus according to claim 8,
wherein in a case where there are a plurality of the elements to which the part of the document belongs, the specification unit specifies an approver associated with each of the plurality of elements, and
wherein in a case where the plurality of approvers are specified, the notification unit notifies of the request in order from an approver associated with a lower element to an approver associated with a higher element.

19. An information processing system comprising:
the information processing apparatus according to claim 1; and
a terminal that receives the approval from the approver in a case where the approval request is notified from the information processing apparatus.

20. A non-transitory computer readable medium storing a program causing a computer to function as:
a detection unit that detects a changed part of a document including a plurality of elements having a hierarchical structure;
a specification unit that specifies an approver associated with an element to which the part belongs in the document; and
a notification unit that notifies the approver of an approval request for the part.
